(19) United States
(12) Patent Application Publication
(10) Pub. No.: US 2012/0000440 A1
(43) Pub. Date: Jan. 5, 2012

(54) Intake Temperature Reducer

(76) Inventor: Michael Sean Gage, Nacogdoches, TX (US)

(21) Appl. No.: 12/830,105

(22) Filed: Jul. 2, 2010

(51) Int. Cl. F02B 77/00

(52) U.S. Cl. 123/198 E

(57) ABSTRACT

Any method used to place a cold, frozen or freezing element on, in or near the intake system, filter element, etc. of an internal combustion engine for the purpose of lowering the intake temperature to increase horse power thereby lowering fuel consumption.

The Intake Temperature Reducer Prototype has been used for approximately 6 weeks as of the date of this statement.

It is used in a 2005 Jeep Wrangler with a 15 gallon fuel tank for a minimum of 4 days per week traveling 104 miles per day.

Before the Prototype was added to the vehicle it was averaging 200 miles per tank of unleaded gasoline in the cooler winter and spring months. In the warmer summer months it was averaging 185 miles per tank of unleaded gasoline.

With the Prototype added to the vehicle, during the warm summer months is now averaging between 275 and 285 miles per tank of unleaded gasoline.

This process results in a much lower fuel consumption and a savings of financial resources as well.

This substitute specification contains no new matter.

1. Any method used to place a cold, frozen or freezing element on, in or near the intake system, filter element, etc. of an internal combustion engine for the purpose of lowering the intake temperature to increase horse power thereby lowering fuel consumption.
